(19) United States
(12) Patent Application Publication
(10) Pub. No.: US 2025/0346825 A1
(43) Pub. Date: Nov. 13, 2025

(54) MEDIA LUBRICANTS SYNTHESIS WITH CLICK CHEMISTRY

(71) Applicant: Western Digital Technologies, Inc., San Jose, CA (US)

(72) Inventors: Hantao Zhou, San Jose, CA (US); Robert James Waltman, Sunnyvale, CA (US); Daniel Demori Maksuta, San Jose, CA (US); Ao Fan, Shenzhen (CN); Jianming Wen, Pleasanton, CA (US); Charles Cheng-Hsing Lee, San Jose, CA (US)

(21) Appl. No.: 18/656,812

(22) Filed: May 7, 2024

(51) Int. Cl. C10M 107/46; C10M 107/40; C10N 40/18; G11B 5/725

(52) U.S. Cl. CPC C10M 107/46; C10M 107/40; G11B 5/7257; C10M 2217/003; C10M 2221/003; C10N 2040/18

(57) ABSTRACT

A lubricant for magnetic media is synthesized using click chemistry. In one aspect the lubricant is according to general formula (I):

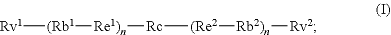

where Rc is a fluorinated or non-fluorinated divalent linking segment; where each Re¹ and Re² is a click linker moiety that can be triazole or sulfone; n is from 2 to 50; where each Rb¹ and Rb² is an optionally non-fluorinated divalent linking segment optionally comprising at least one least one first anchoring functional group engageable with a protective overcoat of a magnetic recording medium; and where each of Rv¹ and Rv², when present, independently comprises a moiety having at least one second anchoring functional group engageable with the protective overcoat of the magnetic recording medium. The click linker moiety may also functional as an anchoring functional group.

### FIELD

The disclosure relates to lubricants, and more particularly, to high temperature lubricants, which may be used with media configured for magnetic recording, e.g., for Heat Assisted Magnetic Recording (HAMR), that are synthesized via specialized click chemistry, including, for example, CuAAC (Copper(I)-catalyzed Azide-Alkyne Cycloaddition) chemistry or SuFEx (sulfur-fluoride exchange) chemistry.

### INTRODUCTION

Magnetic storage systems, such as a hard disk drive (HDD), are utilized in a wide variety of devices in both stationary and mobile computing environments. Examples of devices that incorporate magnetic storage systems include data center storage systems, desktop computers, portable notebook computers, portable hard disk drives, network storage systems, high definition television (HDTV) receivers, vehicle control systems, cellular or mobile telephones, television set top boxes, digital cameras, digital video cameras, video game consoles, and portable media players.

A typical disk drive includes magnetic storage media in the form of one or more flat disks or platters. The disks generally include two main components, namely, a substrate material that gives it structure and rigidity, and a magnetic media coating that stores the magnetic signals that represent data in a recording layer within the coating. The typical disk drive also includes a read head and a write head, generally in the form of a magnetic transducer which can sense and/or change the magnetic fields stored on the recording layer of the disks. HAMR is a recording technique that can increase the areal density capability (ADC) of written data on a magnetic storage medium having very high coercivity with high-temperature assistance. However, the high recording temperatures applied to the media may present challenges. Other examples of magnetic storage media include flexible tape media usable for magnetic tape recording.

As a result of the high temperatures associated with HAMR technology, suitable lubricants for use in HAMR media (or media employing other recording technologies) may benefit from high thermal stability. In addition, the higher temperatures also increase the presence of contaminants which may negatively affect data storage.

The synthesis of high-temperature lubricants has conventionally utilized polymerization and oxidative synthetic pathways. However, these types of conventional synthetic pathways have limitations that inhibit the range of fluorinated lubricants that can be obtained. Moreover, the synthesis of high-temperature fluorinated lubricants can be lengthy and time consuming.

As such, there is a need in the art for high temperature lubricants, with complex topologies, having properties suitable for use in hard disk drives such as HAMR drives, including the ability to sequester and/or remove contaminants prior to the contaminants interfering with data storage or other operational processes. That is, the oxidation resistance of the lubricant of the lubricant will have the stability for a more durable tribochemical interface.

### SUMMARY

In one aspect, this disclosure provides a lubricant comprising a plurality of segments according to general formula (I):

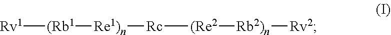

wherein Rc is a fluorinated or non-fluorinated divalent linking segment optionally comprising at least one least one first anchoring functional group engageable with a protective overcoat of a magnetic recording medium;
wherein each Re¹ and Re² is a click linker moiety;
n is from 2 to 50;
wherein each Rb¹ and Rb² is an optionally non-fluorinated divalent linking segment optionally comprising at least one least one first anchoring functional group engageable with a protective overcoat of a magnetic recording medium;
wherein each Re¹ and Re² is a click linker moiety;
n is from 2 to 50; and
wherein each of Rv¹ and Rv², when present, independently comprises a moiety having at least one second anchoring functional group engageable with the protective overcoat of the magnetic recording medium.

In one aspect, the lubricant described above wherein the click linker moiety is:

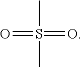

In one aspect, the lubricant described above wherein the click linker moiety is:

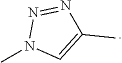

In one aspect, the lubricant described above wherein the at least one first and second anchoring functional groups each comprises at least one of B, Si, a pnictogen, a chalcogen, a halogen, —OR*, —NR*₂, —NR *—CO—R*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

In one aspect, the lubricant described above wherein the at least one first and second anchoring functional groups each comprises a hydroxyl (—OH) moiety.

In one aspect, the lubricant described above wherein the at least one first and second anchoring functional groups are not present.

In one aspect, the lubricant described above having the formula (V):

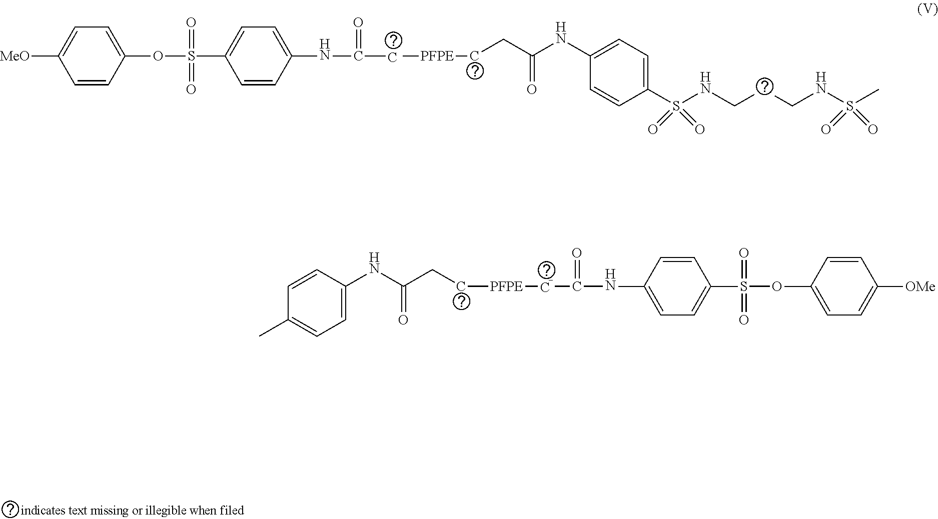

where PFPE is a perfluorinated polyether and each R is one of an alkyl ether moiety, a fluoroalkyl ether moiety, a fluoroalkenyl ether moiety, a perfluoroalkyl ether moiety, a perfluoroalkenyl ether moiety, or a combination thereof.

In one aspect, the lubricant described above having the formula (IX):

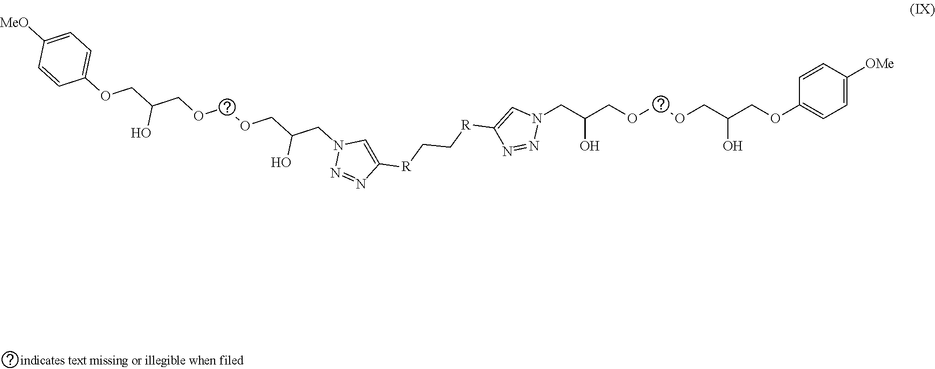

where each R is one of an alkyl ether moiety, a fluoroalkyl ether moiety, a fluoroalkenyl ether moiety, a perfluoroalkyl ether moiety, a perfluoroalkenyl ether moiety, or a combination thereof; D is a perfluoroether group, n is from 2 to 50 and Me is methyl.

In one aspect, the lubricant described above having the formula (X):

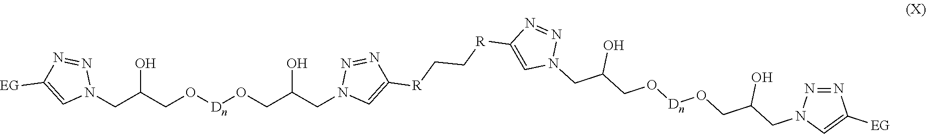

where each R is one of an alkyl ether moiety, a fluoroalkyl ether moiety, a fluoroalkenyl ether moiety, a perfluoroalkyl ether moiety, a perfluoroalkenyl ether moiety, or a combination thereof, D is a perfluoroether group, n is from 2 to 50 and each EG is an end group comprising an aromatic moiety, a substituted or unsubstituted alkyl moiety, alkenyl moiety, fluoroalkyl ether moiety, fluoroalkenyl ether moiety, perfluoroalkyl ether moiety, perfluoroalkenyl ether moiety, or a combination thereof.

In one aspect, a magnetic recording medium, comprising: magnetic recording layer on a substrate; a protective overcoat on the magnetic recording layer; and a lubricant layer comprising the lubricant described above on the protective overcoat.

In one aspect, a data storage system, comprising: at least one magnetic head; a magnetic recording medium including the lubricant described above; a drive mechanism for positioning the at least one magnetic head over the magnetic recording medium; and a controller electrically coupled to the at least one magnetic head for controlling operation of the at least one magnetic head.

In one aspect, a lubricant having the formula (Ia):

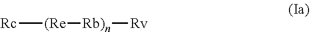

where Rc is a fluorinated or non-fluorinated trivalent, tetravalent, pentavalent, hexavalent, heptavalent, or octavalent linking segment optionally comprising at least one first anchoring functional group engageable with a protective overcoat of a magnetic recording medium;
wherein each Re is a click linker moiety;
   each Rb is a perfluorinated polyether optionally having an anchoring functional group engageable with a protective overcoat of a magnetic recording medium;
   n is 2; and
Rv, if present, is an anchoring functional group.

In one aspect, the lubricant described above wherein Rv is not present.

In one aspect, the lubricant described above wherein the click linker moiety is:

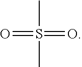

In one aspect, the lubricant described above wherein the click linker moiety is:

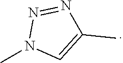

In one aspect, the lubricant described above wherein the anchoring functional groups, if present, each comprises at least one of B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

In one aspect, the lubricant described above wherein the anchoring functional groups, if present, each comprises a hydroxyl (—OH) moiety.

In one aspect, the lubricant described above wherein the anchoring functional groups are not present.

In one aspect, a magnetic recording medium, comprising: a magnetic recording layer on a substrate; a protective overcoat on the magnetic recording layer; and a lubricant layer comprising the lubricant described above on the protective overcoat.

In one aspect, a data storage system, comprising: at least one magnetic head; a magnetic recording medium including the lubricant described above; a drive mechanism for positioning the at least one magnetic head over the magnetic recording medium; and a controller electrically coupled to the at least one magnetic head for controlling operation of the at least one magnetic head.

Other aspects and advantages of the present disclosure will become apparent from the following detailed description and examples, when considered in conjunction with the drawings.

### BRIEF DESCRIPTION OF THE DRAWINGS

FIG. 1A is a diagram schematically illustrating a data storage device including a slider and a magnetic recording medium in accordance with one aspect of the disclosure.

FIG. 1B is a side schematic view of the slider and magnetic recording medium of FIG. 1A in accordance with one aspect of the disclosure.

FIG. 2 is a side schematic view of a head assisted magnetic recording (HAMR) medium in accordance with one aspect of the disclosure.

FIG. 3A is a schematic drawing showing a lubricant according to general formula (II) of the disclosure comprising a single main chain segment and a cyclic functional group according to one aspect of the disclosure.

FIG. 3B is a schematic drawing showing a lubricant according to general formula (II) of the disclosure comprising a single main chain segment and a multitude of cyclic functional groups according to one aspect of the disclosure.

FIG. 3C is a schematic drawing showing a lubricant according to general formula (III) of the disclosure comprising two chain segments comprising terminal cyclic functional groups and separated by a linking segment according to one aspect of the disclosure.

FIG. 3D is a schematic drawing showing a lubricant according to general formula (III) of the disclosure comprising two chain segments comprising terminal cyclic functional groups and separated by a linking segment comprising cyclic functional groups according to one aspect of the disclosure.

FIG. 3E is a schematic drawing showing a lubricant according to general formula (IV) of the disclosure comprising two chain segments comprising terminal cyclic functional groups and separated by a linking segment according to one aspect of the disclosure.

FIG. 4 is a graph showing the results for the thermogravimetric analysis (TGA) of a fluorinated lubricant compared to a non-fluorinated lubricant and a non-fluorinated lubricant containing benzene rings, according to aspects of the disclosure.

FIG. 5 shows the lifetime of various test lubricants grouped by lubricant type, according to aspects of the disclosure.

FIG. 6 is a conceptual drawing of incorporation using click chemistry, according to aspects of the disclosure.

FIG. 7 shows the concept of molecular building with SuFEx click chemistry, according to aspects of the disclosure.

FIG. 8 shows the synthesis of a fluorinated lubricant via SuFEx click chemistry, according to aspects of the disclosure.

FIG. 9 shows ball-and-stick models of optimized dimer geometry, according to aspects of the disclosure.

FIG. 10 shows an efficient route to lubricant synthesis and purification is achieved by combining epoxide and CuAAC chemistries, according to aspects of the disclosure.

FIG. 11 shows an alternative approach to combining epoxide and CuAAC chemistries, according to aspects of the disclosure.

FIG. 12 shows an approach where the primary chemistry can be CuAAC, according to aspects of the disclosure.

FIG. 13 shows examples of linear shaped fluorinated lubricants with click linkers, according to aspects of the disclosure.

FIG. 14 is a flowchart of an exemplary process for fabricating, for example, a HAMR medium that includes a lubricant, according to aspects of the disclosure.

### DETAILED DESCRIPTION

Heat Assisted Magnetic Recording (HAMR) systems operate at substantially higher temperatures than traditional magnetic recording systems. HAMR is an example of magnetic recording within the class of Energy Assisted Magnetic Recording (EAMR) techniques, where conventional magnetic recording is supplemented by other energy used in the system. Other examples of EAMR may include Microwave Assisted Magnetic Recording (MAMR) and applications of electric current into various conductive and/or magnetic structures near the main pole. This disclosure is generally directed to lubricants having high thermal stability that can be used in conjunction with a magnetic recording medium and/or a magnetic data storage system including a HAMR, or more generally EAMR, magnetic recording medium or storage system. These lubricants may also be used in recording technologies such as Perpendicular Magnetic Recording (PMR), Enterprise Perpendicular Magnetic Recording (ePMR), Shingled Magnetic Recording (SMR), or any other magnetic recording technology employing lubricants on magnetic media (e.g., magnetic recording disks or magnetic recording tape).

The synthesis of high-temperature lubricants has conventionally utilized polymerization and oxidative synthetic pathways. These synthetic pathways include the functionalization of perfluoropolyethylene (PFPE) under the catalysis of cesium fluoride (CsF), i.e., how to connect PFPE or end functionalize PFPE. However, these types of conventional synthetic pathways have limitations that inhibit the range of fluorinated lubricants that can be obtained. Moreover, the synthesis of high-temperature fluorinated lubricants can be lengthy and time consuming.

In short, the disclosure pertains to lubricants with novel structures obtained via click chemistry. Click chemistry permits the production of advanced designs with complex topological structures. Click chemistry produces lubricants with enhanced thermal stability and clearance gain.

In one aspect, one such lubricant comprises or is according to general formula (I):

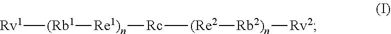

where Rc is a fluorinated or non-fluorinated divalent linking segment optionally having at least one least one first anchoring functional group engageable with a protective overcoat of a magnetic recording medium; where each Re¹ and Re² is a click linker moiety; where each Rb¹ and Rb² independently is a click linked chain segment having at least one of a fluoroalkyl ether moiety, a fluoroalkenyl ether moiety, a perfluoroalkyl ether moiety, a perfluoroalkenyl ether moiety, or a combination thereof; and where each of Rv¹ and Rv², when present, independently is a moiety having at least one second anchoring functional group engageable with the protective overcoat of the magnetic recording medium. However, the second anchoring functional group is optional because the click linkages can act as anchoring functional groups. Other types of molecular geometries can include stars, branches, rings, dendrimers, etc.The click linkers of the disclosure can arise from either CuAAC (Copper(I)-catalyzed Azide-Alkyne Cycloaddition) click chemistry, which can be in conjunction with epoxides or SuFEx (sulfur-fluoride exchange) click chemistry. The click linkers can be either:

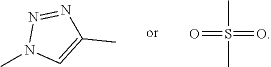

### Definitions

As used herein, and unless otherwise specified, the term “Cₙ” means hydrocarbon(s) having n carbon atom(s) per molecule, where n is a positive integer. Likewise, a “Cₘ-C_{y}” group or compound refers to a group or compound comprising carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

“Moiety” refers to one or more covalently bonded atoms which form a part of a molecule. The terms “group,” “radical,” “moiety”, and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₅₀ radicals that may be linear, branched, or cyclic, and when cyclic, aromatic or non-aromatic. Examples of such radicals include, but are not limited to, alkyl groups such as methyl, cthyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like, aryl groups, such as phenyl, benzyl naphthyl, and the like.

For purposes herein, a “heteroatom” is any non-carbon atom, selected from groups 13 through 17 of the periodic table of the elements. In one or more aspects, heteroatoms are non-metallic atoms selected from B, Si, pnictogens (N, P, As, Sb, Bi), chalcogen (O, S, Se, Te), and halogens (F, Cl, Br, I).

Unless otherwise indicated, the term “substituted” means that at least one hydrogen atom has been replaced with at least one non-hydrogen atom or a functional group.

For purposes herein, when a segment comprises or includes a particular moiety, it is to be understood that the moiety may be bonded to the respective segment at any substitutable position in which a hydrogen atom may be replaced with a chemical bond between the moiety and the segment.

For purposes herein, a functional group includes one or more of a hydrocarbyl group, a heteroatom, or a heteroatom containing group, such as B, Si, pnictogen, chalcogen, or halogen (such as Br, Cl, F or I), at least one of —OR*, —NR*₂, —NR*—CO—R*, —OR*, R*—O—CO—R*, —CO—O—R*, —SeR*, —TeR*, —PR*₂, P(III) groups including —P(OR)₂, —PO—(OR*)₂, and —O—PO—(OR*)₂, —AsR*₂, —SbR*₂, —SR*, —SO₂—(OR*)₂, —BR*₂, —SiR*₃, —(CH₂)_{q}—SiR*₃, or a combination thereof, wherein q is 1 to 10 and each R* is independently a hydrogen, a hydrocarbyl or a halocarbyl radical, and two or more R* may join together to form a substituted or unsubstituted completely saturated, partially unsaturated, or aromatic cyclic or polycyclic ring structure, or where at least one heteroatom has been inserted within a hydrocarbyl ring. In an aspect, R* is H such that the functional group may be —OH, —NH₂, —NH—CO—H, —OH, H—O—CO—H, —CO—O—H, —SeH, —TeH, —PH₂, P(III) groups including —P(OH)₂, —PO—(OH)₂, and —O—PO—(OH)₂, —AsH₂, —SbH₂, —SH, —SO2—(OH)₂, —BH₂, —SiH₃, —(CH₂)_{q}—SiH₃, or a combination thereof.

In one or more aspects, functional groups may include: a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, P(III) groups including —P(OR)₂, —PO—(OR*)₂ and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen, a chalcogen, a halogen, or a saturated, unsaturated, aromatic, polycyclic aromatic, heteroaromatic, alicyclic, and/or heterocyclic C₄-C₅₀ radical. Anchoring functional groups can also be least one of —OH, —NH₂, —NH—CO—H, —O—CO—H, —CO—O—H, —SeH, —TeH, —PH₂, P(III) groups including —P(OH)₂, —PO—(OH)₂, and —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

For purposes herein, a cyclic functional group is a monovalent alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. Unless otherwise indicated, the cyclic functional group may be further substituted with another cyclic functional group and/or with one or more functional groups comprising one or more of a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, B, Si, a pnictogen, a chalcogen, or a halogen, —OR*, —NR*₂, —NR*—CO—R*, —OR*, —O—CO—R*, —CO—O—R*, —SeR*, —TeR*, P(III) groups including —PR*₂, —PO—(OR*)₂, and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or a heterocyclic C₁-C₅₀ radical.

For purposes as described herein, an anchoring functional group which is selected for being attachable to and/or engageable with a protective overcoat of a magnetic recording medium refers to a functional group having increased affinity for the protective overcoat of a magnetic recording medium relative to the affinity of a fluoroalkenyl ether moiety, a perfluoroalkyl ether moicty, a perfluoroalkenyl ether moieties, to that same surface. Increased affinity may include Van der Waals forces, weak London Dispersion forces, dipole-dipole forces, polar interactions, polarizability/hydrogen bonding interactions, and/or the like, and/or may include the formation of one or more types of bonds, backbonding (the exchange of electrons between an atomic orbital on one atom and an anti-bonding orbital on another atom), and/or dative bonds (a covalent bond (a shared pair of electrons) in which both electrons come from the same atom) with the protective overcoat of a recording medium. In one or more aspects, a functional group which is attachable to and/or engageable with a protective overcoat of a magnetic recording medium refers to one or more functional groups having increased affinity for the carbon overcoat (COC) layer of the recording medium, relative to the affinity of a fluoroalkenyl ether moicty, a perfluoroalkyl ether moiety, a perfluoroalkenyl ether moieties to that same surface. In some aspects, functional groups attachable to and/or engageable with a protective overcoat of a magnetic recording medium include radicals comprising one or more hydroxyl moicties (—OH), or comprising a hydroxyl moiety (—OH).

A “heterocyclic ring,” also referred to herein as a heterocyclic radical, is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring is a heterocyclic ring where a hydrogen of one of the ring atoms is substituted, e.g., replaced with a hydrocarbyl, or a heteroatom containing group.

A “compound” refers to a substance formed by the chemical bonding of a plurality chemical elements. A “derivative” refers to a compound in which one or more of the atoms or functional groups of a precursor compound have been replaced by another atom or functional group, generally by means of a chemical reaction having one or more steps.

Fluorinated alkyl ethers including fluoroalkyl ethers, fluoroalkenyl ethers, perfluoroalkyl ethers, perfluoroalkenyl ethers, or combinations thereof, refer to branched or linear chain of C₁ to C₂₀ alkyl ethers in which one or more hydrogen atoms are substituted with fluorine. In one aspect, all or a majority of alkyl hydrogen atoms are substituted with fluorine.

For any particular compound disclosed herein, any general or specific structure presented also encompasses all conformational isomers, regio-isomers, and stereoisomers that may arise from a particular set of substituents, unless stated otherwise. Similarly, unless stated otherwise, the general or specific structure also encompasses all enantiomers, diastercomers, and other optical isomers whether in enantiomeric or racemic forms, as well as mixtures of stereoisomers, as would be recognized by a skilled artisan.

As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

As used herein, the term percent (%), where the unit is not specified, can be any one of weight %, atomic %, mole %, mass % or volume %.

As used herein, a moiety which is chemically identical to another moiety is defined as being identical in overall composition exclusive of isotopic abundance and/or distribution, and/or exclusive of stereochemical arrangement such as optical isomers, confirmational isomers, spatial isomers, and/or the like.

### HAMR System for Employing Lubricant

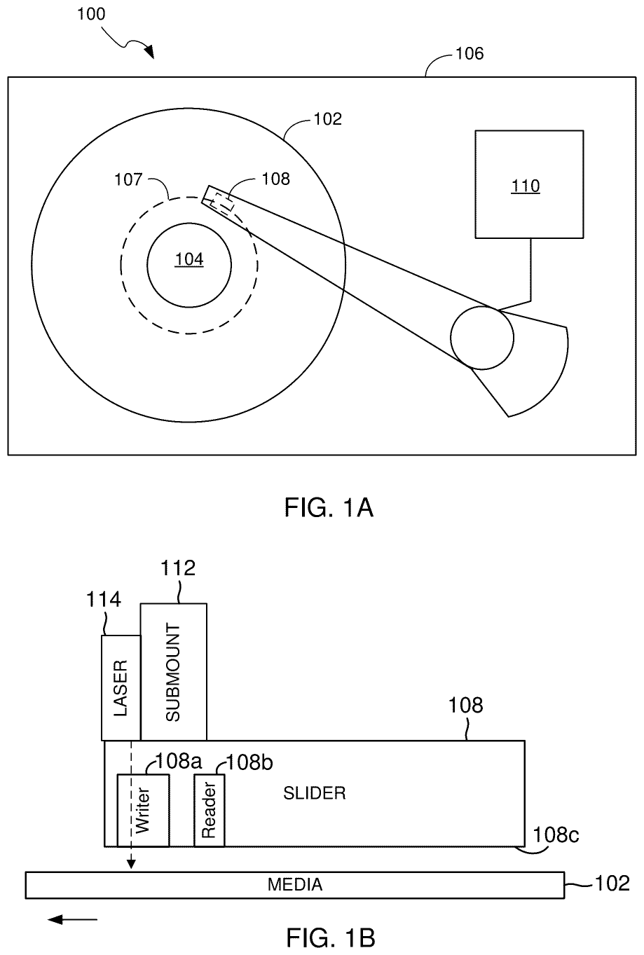

FIG. 1A is a top schematic view of a data storage device 100 (e.g., disk drive or magnetic recording device) configured, for example, for heat assisted magnetic recording (HAMR) including a slider 108 and a magnetic recording medium 102 having a lubricant according to one or more aspects of the disclosure. The laser (not visible in FIG. 1A but see 114 in FIG. 1B) is positioned with a head/slider 108. Disk drive 100 may include one or more disks/media 102 to store data. The disks/media 102 reside on a spindle assembly 104 that is mounted to a drive housing. Data may be stored along tracks in the magnetic recording layer of disk 102. The reading and writing of data is accomplished with the read and write elements (108a and 108b). The write element 108a is used to alter the properties of the magnetic recording layer of disk 102 and thereby write information thereto. In one aspect, head/slider 108 may have magneto-resistive (MR), giant magneto-resistive (GMR), or tunnel magneto-resistive (TMR) elements. In an alternative aspect, head/slider 108 may be another type of head, for example, a Hall effect head. In operation, a spindle motor (not shown) rotates the spindle assembly 104, and thereby rotates the disk 102 to position the head/slider 108 at a particular location along a desired disk track 107. The position of the head 108 relative to the disk 102 may be controlled by the control circuitry 110 (e.g., a microcontroller). It is noted that while an example HAMR system is shown, the various embodiments described may be used in other EAMR or non-EAMR magnetic data recording systems, including perpendicular magnetic recording (PMR) disk drives or magnetic tape drives.

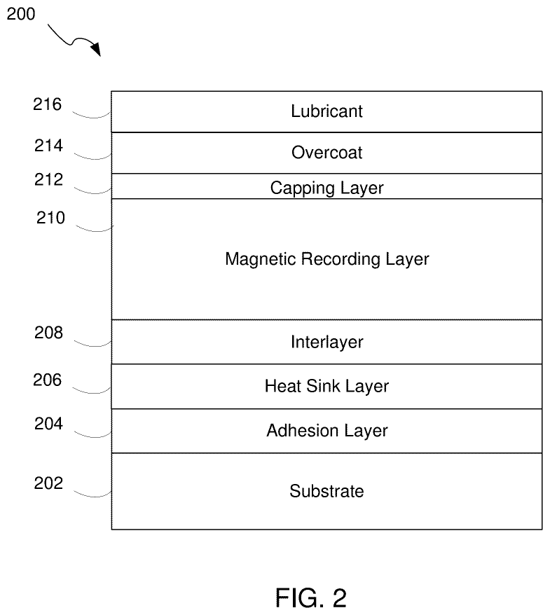

FIG. 1B is a side schematic view of the slider 108 and magnetic recording medium 102 of FIG. 1A. The magnetic recording medium 102 includes a lubricant layer (see FIG. 2) in accordance with one or more aspects of the disclosure. The slider 108 may include a sub-mount 112 attached to a top surface of the slider 108. The laser 114 may be attached to the sub-mount 112, and possibly to the slider 108. The slider 108 includes a write element (e.g., writer) 108a and a read element (e.g., reader) 108b positioned along an air bearing surface (ABS) 108c of the slider for writing information to, and reading information from, respectively, the medium 102. In other aspects, the slider may also include a layer of the lubricant (not shown).

In operation, the laser 114 is configured to generate and direct light energy to a waveguide (possibly along the dashed line) in the slider which directs the light to a near field transducer (NFT) near the air bearing surface (e.g., bottom surface) 108c of the slider 108. Upon receiving the light from the laser 114 via the waveguide, the NFT generates localized heat energy that heats a portion of the medium 102 near the write clement 108a and the read element 108b. The anticipated recording temperature is in the range of about 350° C. to 400° C. In the aspect illustrated in FIG. 1B, the laser directed light is disposed between the writer 108a and a trailing edge of the slider. In other aspects, the laser directed light may instead be positioned between the writer 108a and the reader 108b. FIGS. 1A and 1B illustrate a specific aspect of a HAMR system. In other aspects, the magnetic recording medium 102 with the lubricant layer according to aspects of the disclosure can be used in other suitable HAMR systems (e.g., with other sliders configured for HAMR).

FIG. 2 is a side schematic view of a magnetic recording medium 200 having a lubricant layer according to one or more aspects of the disclosure. In one aspect, the magnetic recording medium 200 may be used in a HAMR system (e.g., disk drive 100). The magnetic recording medium 200 has a stacked structure with a substrate 202 at a bottom/base layer, an adhesion layer 204 on the substrate 202, a heat sink layer 206 on the adhesion layer 204, an interlayer 208 on the heat sink layer 206, a magnetic recording layer (MRL) 210 on the interlayer 208, a capping layer 212 on the MRL 210, an overcoat layer 214 on the capping layer 212, and a lubricant layer 216 on the overcoat layer 214. In one aspect, the magnetic recording medium 200 may have a soft magnetic underlayer (SUL) between the adhesion layer 204 and the heat sink layer 206. In one aspect, the magnetic recording medium 200 may have a thermal resistance layer (TRL) between the interlayer 208 and the heat sink layer 206. In one aspect, for disk drive applications, the substrate 202 can be made of one or more materials such as an Al alloy, NiP plated Al, glass, glass ceramic, and/or combinations thereof. In one aspect for magnetic tape recording applications, the substrate 202 can include a flexible material, such a film made of one of various types of resins, polyesters, polyolefins, polyamides, and the like, or combinations thereof. The substrate may include non-magnetic materials, and may be laminated. In some aspects, the magnetic recording medium 200 may have some or all of the layers illustrated in FIG. 2 and/or additional layer(s) in various stacking orders. It should also be noted that each layer shown in FIG. 2 may include one or more sub-layers. For example, the magnetic recording layer may comprise a multiple layers in certain embodiments. Also, some of the layers may be etched before the next layer is applied. In one aspect, the overcoat layer 214 may be made of carbon (e.g., diamond like carbon or DLC). The remaining layers of the magnetic recording medium 200 may be formed of suitable materials known in the art.

### Lubricants

Lubricants according to aspects disclosed herein may function as boundary lubricants which may be used in various mechanical devices, including on the magnetic media of hard disk drives or tape drives and in conjunction with other microelectronic mechanical systems. Boundary lubricants may form a lubricant layer when one or more functional groups of the lubricant attach or otherwise engage with the surface being lubricated. For instance, one or more boundary lubricants may form the lubricant layer 216 on magnetic recording medium 200 (e.g., a disk that includes a magnetic recording layer 210) that moves relative to other parts in the magnetic storage device. This lubricant layer 216 helps to protect the magnetic recording medium from friction, wear, contaminations, smearing, and/or damages caused by interactions between the magnetic recording medium and other parts in the storage device (e.g., interactions between a slider and the magnetic recording medium). In other words, this boundary layer may help limit solid-to-solid contact.

While the HDD examples illustrated in FIGS. 1A, 1B, and 2 primarily relate to HAMR technology that involves the use of lubricants, the lubricants described herein may also be used in other magnetic recording technologies. These may include Microwave Assisted Magnetic Recording (MAMR), Perpendicular Magnetic Recording (PMR), Enterprise Perpendicular Magnetic Recording (ePMR), Shingled Magnetic Recording (SMR), or any other magnetic recording technology employing lubricants on magnetic media (e.g., magnetic recording disks or magnetic recording tape).

### Lubricant Characteristics

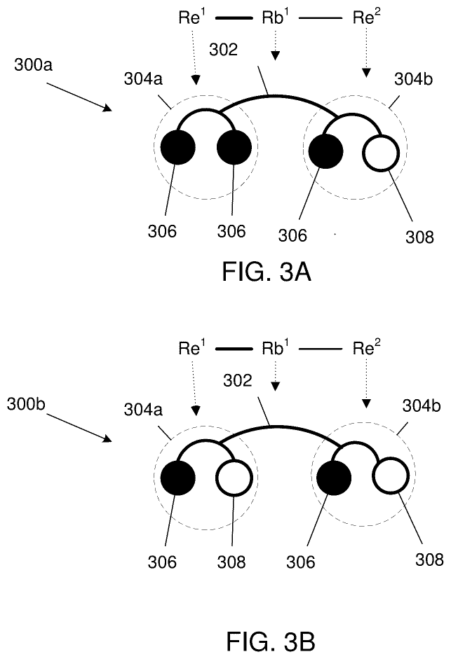

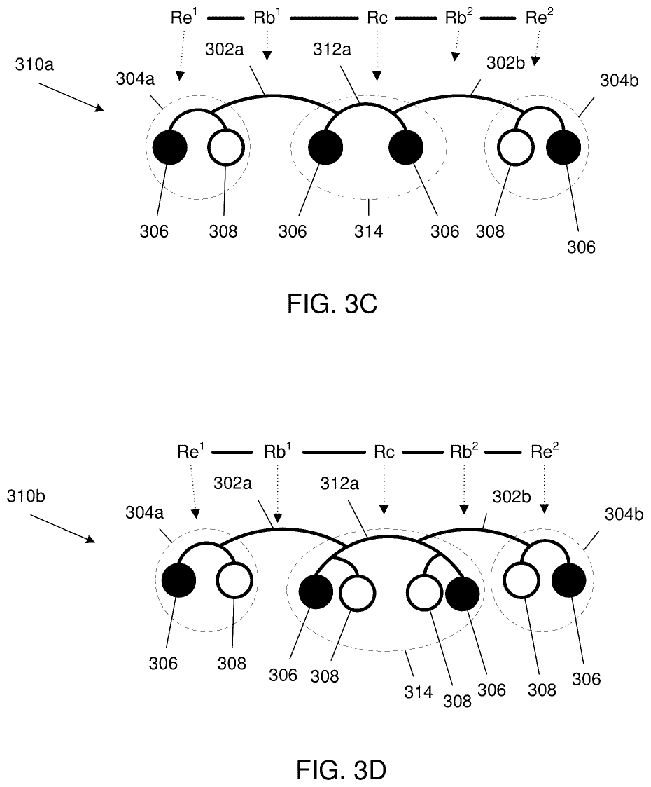

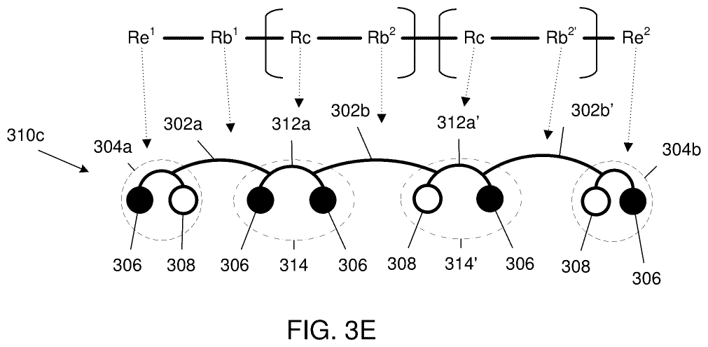

FIG. 3A-3D illustrate boundary lubricants according to aspects of the disclosure. In one aspect as shown in FIG. 3A, the boundary lubricant generally referred to as 300a comprises or may have general formula (II):

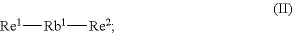

wherein Rb¹ (302) comprises or is a chain segment including an alkyl, alkenyl, fluoroalkyl, fluoroalkenyl, perfluoroalkyl, or perfluoroalkyl ether moiety bonded on either side to an end segment 304a and 304b. Rb¹ may be non-fluoridated, contain anchoring functional groups and may contain aromatic, e.g., benzene, rings, which may include the click linker moieties of the disclosure. In the aspect shown in FIG. 3A, the chain segment Rb¹ (302) may be also be referred to as a main chain segment. Each of Re¹ (304a) and Re² (304b) is an end segment which independently includes an anchoring functional group 306 selected for being attachable to and/or engageable with a protective overcoat of a magnetic recording medium (see FIG. 2).

As shown in FIG. 3B, in one aspect indicated as 300b, each end group segment may include an optional functional group 308 that can be as simple as an —OH group.

In one aspect as shown in FIG. 3C, the boundary lubricant generally referred to as 310a may comprise or has general formula (III):

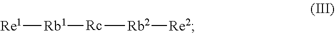

where the end segments Re¹ (304a) and Re² (304b) are as described above; in this aspect there are two chain segments Rb¹ (302a) and Rb² (302b), which may also be referred to herein as sidechain segments, both of which independently comprises a fluoroalkyl, fluoroalkenyl, perfluoroalkyl, or perfluoroalkyl ether moiety, as well as click linker moieties.

As is indicated in FIG. 3C, whether referred to as a chain segment, a main chain segment (when only one is present), or a sidechain segment (when two or more are present), each of the segments are similar to one another in that each segment comprises an alkyl, alkenyl, fluoroalkyl, fluoroalkenyl, perfluoroalkyl, or perfluoroalkyl ether moiety.

In the aspect shown in FIG. 3C, the lubricant may further include a divalent linking segment Rc (312), generally indicated as 314, also referred to herein as a center segment, which is disposed between either end of the sidechain segments 302a and 302b, and which optionally includes at least one anchoring functional group (306) as defined herein, as well as at least one group that has a higher rotational energy than CH₂, which for example can be an aromatic group, e.g., benzene, or a click linker moiety of the disclosure. In an embodiment, Rc is non-fluorinated. The divalent linking segment optionally includes aromatic moieties which act to stiffen the center of the molecule. The aromatic moieties, e.g., benzene, or the click linker moieties, impact both the chain stiffness and solubility differently than fluorination.

As shown in FIG. 3D, in one aspect generally indicated as 310b, the divalent linking segment Rc (312) may further include at least one functional group 308 as defined herein.

In one aspect as shown in FIG. 3E, the boundary lubricant generally referred to as 310c may comprise or has general formula (IV):

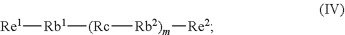

wherein m=2, comprising two units of the divalent linking segments, each optionally containing an aromatic moiety or a moiety that has a higher rotational energy than CH₂, i.e., a click linker moicty; a first unit comprising Rc (312a) also generally indicated as (314), attached to a chain segments Rb² (302b), which is attached to a second unit comprising Rc (312a′) also generally indicated as (314′) and a second chain segment Rb² (302b′). In the disclosure, the Rc units may be a click linker moiety such as 1,2,3-triazole or sulfone. The end segments Re¹ (304a) and Re² (304b) are attached to ether end of the molecule. The composition of each of the segments may be independent of one another. The composition of each of the segments is according to the description of general formula (I) herein. In an embodiment, Rc contains at least one anchoring functional group, is non-fluorinated and contains at least one aromatic constituent, e.g., a benzene ring. In an embodiment, Rc contains two aromatic constituents.

In one aspect, each anchoring functional group, if present, may independently comprises a B, Si, pnictogen, chalcogen, or halogen, —OR*, —NR*₂, —NR*—CO—R*, —OR*, —O—CO—R*, —CO—O—R*, —SeR*, —TeR*, P(III) groups including —P(OR)₂, —PR*₂, —PO—(OR*)₂, and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or heterocyclic C₁-C₅₀ radical, and two or more R* may join together to form a ring structure. Frequently, the anchoring functional group may be hydroxyl (—OH).

In one aspect, each cyclic functional group may further comprise, e.g., may be further substituted with a functional group comprising at least one of a B, Si, pnictogen, chalcogen, or halogen, —OH, —NH₂, —NH—CO—H, —OH, —O—CO—H, —CO—O—H, —SeH, —TeH, P(III) groups including —P(OH)₂, —PH₂, —PO—(OH)₂, and —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof, wherein q is 1 to 10.

In one aspect, one or more anchoring functional group, if present, may include, or is, a hydroxyl (—OH) moiety. In one aspect, each anchoring functional group includes or is a hydroxyl (—OH) moiety. In some aspects, one or more cyclic functional groups may include a hydroxyl (—OH) moiety. In some aspects, each cyclic functional group is a hydroxyl (—OH) moiety.

### Click Chemistry

The lubricants of the disclosure can be achieved by utilizing click chemistry, typified by SuFEx chemistry and CuAAC chemistry.

SuFEx (sulfur-fluoride exchange) chemistry is a sulfur (VI) chemistry based transformations that enable the synthesis of covalently linked modules via S^{VI} hubs. Thionyl tetrafluoride (SOF₄) is utilized a multidimensional SuFEx connector. SOF₄ sits between the commercially mass-produced gases SF₆ and SO₂F₂, and like them, is readily synthesized on scale. Under SuFEx catalysis conditions, SOF₄ reliably seeks out primary amino groups [R—NH₂] and becomes permanently anchored via a tetrahedral iminosulfur (VI) link: R—N═(O═)S(F)₂. The pendant, prochiral difluoride groups R—N═(O═)SF₂, in turn, offer two further SuFEx-able handles, which can be sequentially exchanged to create 3-dimensional covalent departure vectors from the tetrahedral sulfur(VI) hub.

CuAAC (Copper(I)-catalyzed Azide-Alkyne Cycloaddition) chemistry is a 1,3-dipolar copper catalyzed variant of cycloaddition between an azide and a terminal or internal alkyne to give a 1,2,3-triazole. A typical CuAAC reaction is as follows:

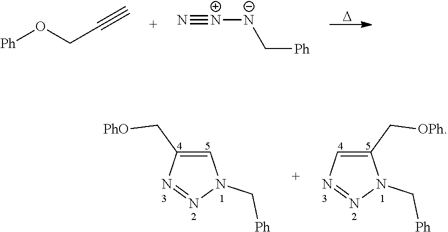

HDDs configured for HAMR, when coated with lubricant, may be exposed to laser radiation on the medium over varying amounts of time, and the intensity of the laser radiation may result in the production of a nitrogenated carbonaceous material (CNₓ) smear problem. These above noted chemistries can be used to address the HDD smear problem. The mechanism works on the surface of a magnetic recording medium that has a magnetic recording layer topped with a capping layer, a protective carbon overcoat layer and a layer of lubricant, as can be seen in FIG. 2. Under laser irradiation (e.g., high heat from a near field transducer or NFT) at some initial time, nitrogenated carbonaceous material may be formed in the carbon overcoat layer. As time proceeds, more nitrogenated carbonaceous material may be formed, and some of the nitrogenated carbonaceous material and some of the lubricant make their way on to the NFT. This smear may deteriorate the recording performance of the HDD system (e.g., operation of slider, NFT and medium to record and read information), such that the flying height (FH) of the slider/NFT gradually increases. This increased flying height lowers the recording performance of the HDD system since the read and write operations on the media occur at a greater distance from the slider (containing the NFT and read and write elements).

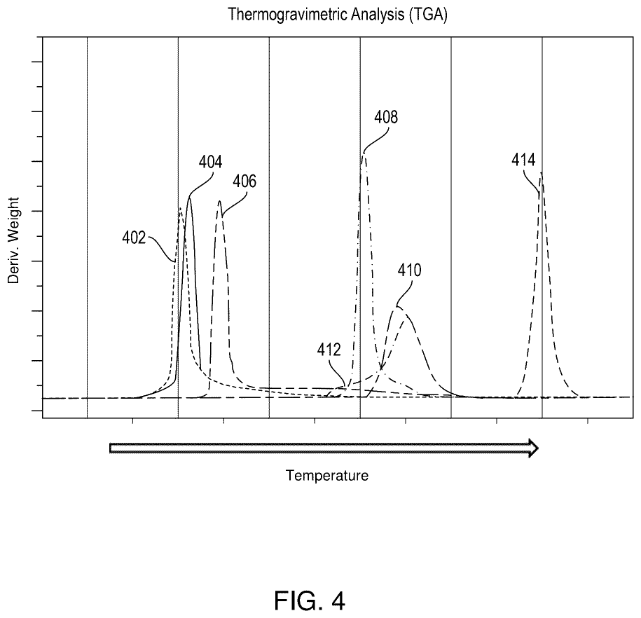

FIG. 4 is a graph showing the results for the thermogravimetric analysis (TGA) of a fluorinated lubricant compared to a non-fluorinated lubricant and a non-fluorinated lubricant containing benzene rings, according to aspects of the disclosure. The problems noted above are further elucidated in the thermogravimetric analysis (TGA) graph in FIG. 4. The lubricants include perfluorinated polyether (PFPE) with —OH anchoring groups 402, PFPE lubricant 404 and PFPE backbone with anchoring groups 406. Non-fluorinated polyurethane lubricant 408 has an approximately midrange peak. Non-fluorinated lubricant 410 and non-fluorinated lubricant with benzene rings 412 come off at a slightly higher temperature. The ideal lubricant 414 will not change until a higher temperature is reached.

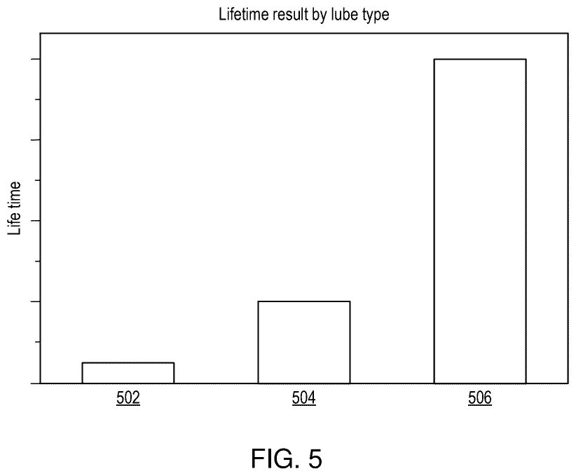

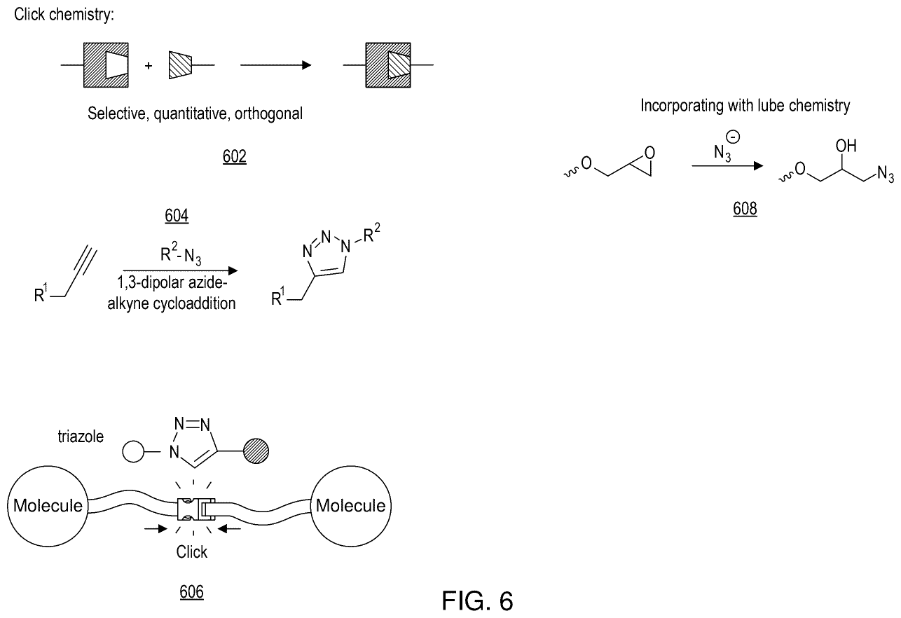

FIG. 5 shows the lifetime of various test lubricants grouped by lubricant type, according to aspects of the disclosure. The lifetime was determined by placing the lubricant on a magnetic recording medium of a magnetic storage device configured for HAMR (e.g., hard disk drive or HDD) and measuring the time to failure under elevated conditions. The PFPE with —OH anchoring groups control 502 had a mean lifetime of less than 100 hours. The PFPE backbone with anchoring groups 504 did better. Better results were seen for the nonfluorinated polyurethane lubricant samples 506. The results in FIG. 5 and FIG. 6 show that by introducing various new lube designs as presented herein, the thermal stability of the lubricants improved dramatically. A strong correlation between HDD lifetime result and lubricant TGA peak temperature is observed.

FIG. 6 is a conceptual drawing of incorporation using click chemistry based on CuAAC, in accordance with an aspect of the disclosure. Selective, quantitative and orthogonal snap-in bonding 602 is achieved using 1,3-dipolar azide-alkyne cycloaddition using a copper catalyzed azide 604 to yield a linked chain with 1,2,3-triazole when the next link is “clicked” 606 to the chain. Reaction with an epoxide 608 can produce a lubricant of the disclosure.

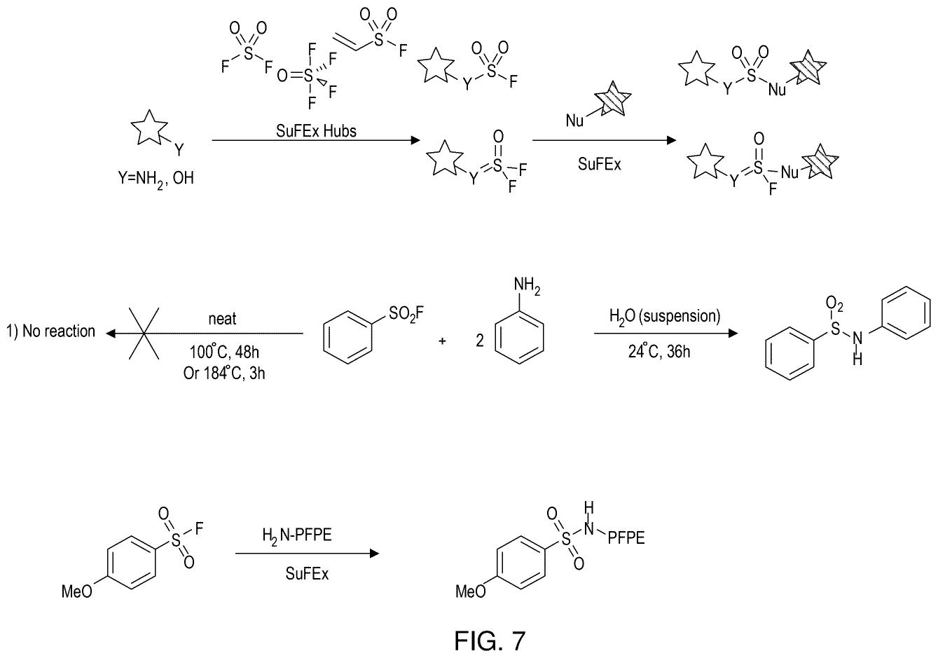

FIG. 7 shows the concept of molecular building with SuFEx click chemistry, according to aspects of the disclosure. SuFEx linkers can be SF₂O₂, SOF₄ or SO₂FCH═CH₂—. Attachment is with a hub with an —NH₂ or —OH end group. An anisole group promotes lubricant binding. An option is a thermally stable anisole group binding with sulfonyl amide. The resulting click lubricant is characterized by having NH groups in the chain as well as sulfonyl groups. Reaction with aniline and a perfluoropolyether (PFPE) amine can yield PFPE chain with anisole end group linked by an —SO₂—NH— click bond.

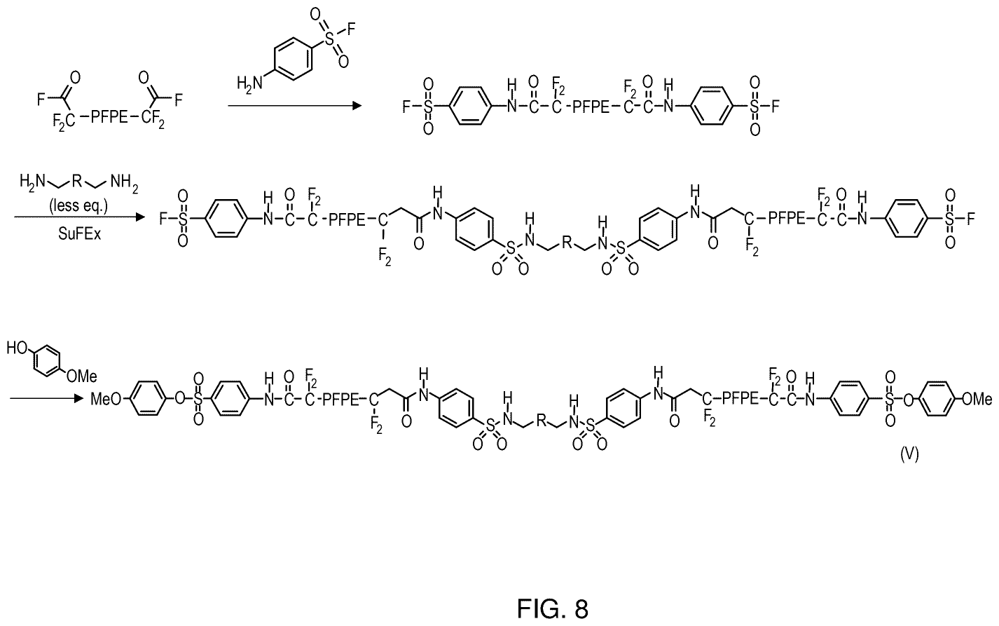

FIG. 8 shows the synthesis of a fluorinated lubricant via SuFEx click chemistry, according to aspects of the disclosure. More specifically, FIG. 8 shows the synthesis of a lubricant starting from PFPE acid fluoride combined with fluorosulfonyl aniline using SuFEx chemistry to yield a PFPE based molecule with fluorosulfonyl end groups. Reaction with 4-hydroxy anisole yields as compound with anisole end groups:

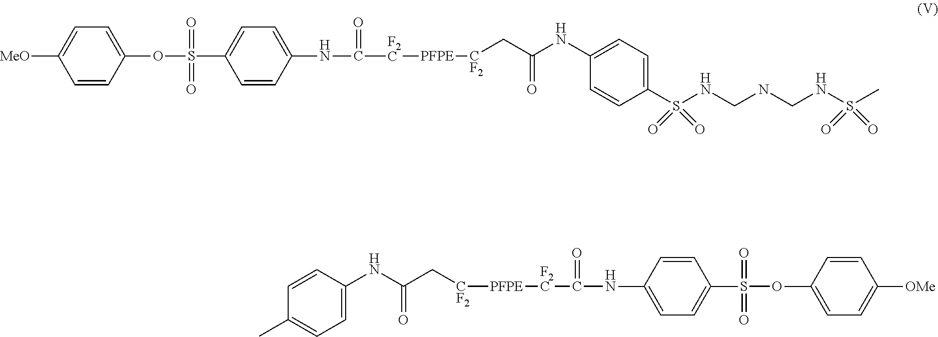

where PFPE is a perfluorinated polyether and R is where each R is one of an alkyl ether moiety, a fluoroalkyl ether moiety, a fluoroalkenyl ether moiety, a perfluoroalkyl ether moiety, a perfluoroalkenyl ether moiety, or a combination thereof.

In this reaction an acidic proton promotes lubricant binding. The compound terminates with thermally stable anisole group with sulfonyl amide. It is notable that there is no anchoring functional group such as —OH in the molecule. The sulfonyl group O═S═O of the click bond has sufficient electron density such that is acts as the anchoring moiety by readily adhering to the protective overcoat layer of a magnetic recording medium.

Other anchoring functional groups which are optional and not necessary in SuFEX and CuAAC formed lubricants include B, Si, a pnictogen, a chalcogen, a halogen, —OR*, —NR*₂, —NR*—CO—R*, —O—CO—R*, —CO—O—R*, —SeR*, —TeR*, P(III) groups including —P(OR)₂, —PR*₂, —PO—(OR*)₂, and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

Additional anchoring functional groups which are optional and not necessary in SuFEx and CuAAC formed lubricants include OH, —NH₂, —NH—CO—H, —O—CO—H, —CO—O—H, —SeH, —TeH, —PH₂, P(III) groups including —P(OH)₂, —PO—(OH)₂ and —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

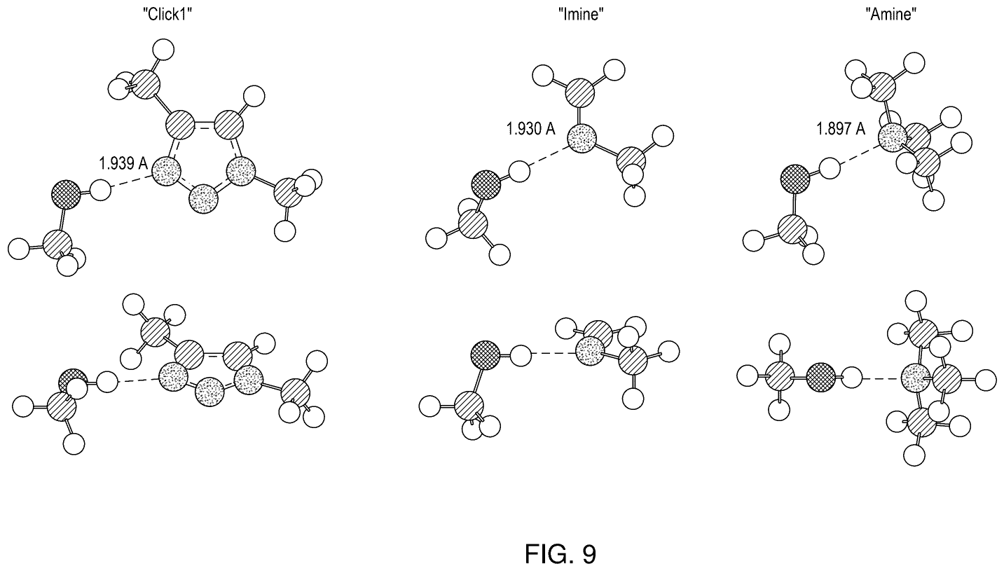

FIG. 9 shows ball-and-stick models of optimized dimer geometry in CuAAC click chemistry, according to aspects of the disclosure. The models show the COC (carbon-oxygen-carbon) affinity of the 1,2,3-triazole adduct. In “Click 1” (bonding to an alcohol) 1,2,3-triazole has a bonding length of 1.939 Å. The “Imine” bonding length is 1.930 Å. The “Amine” bonding length is 1.897 Å. As can be seen, the bonding lengths are similar and the CuAAC adduct has a strong lubricant COC interaction similar to amines and imines.

End group modification can be used to modulate the properties of the lubricants. The types of end groups are as follows:

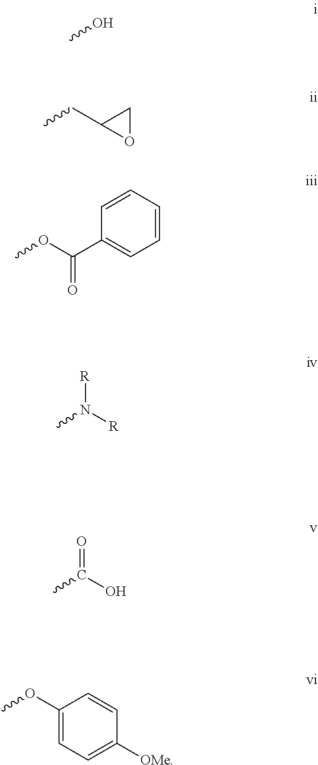

Heterocyclic end groups can be based on anisole or 4-methoxypyridine:

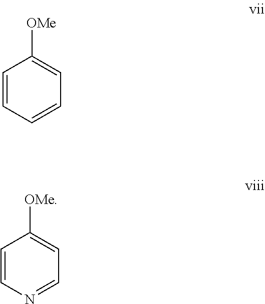 [SMILES: COc1ccccc1 ; COc1ccncc1]

Also 2-methoxypyridine and 3-methoxypyridine can be utilized:

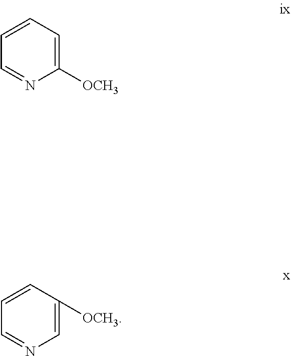 [SMILES: COc1ccccn1 ; COc1cccnc1]

Other end groups can be fluoro-substituted PAHs (not limited to benzene):

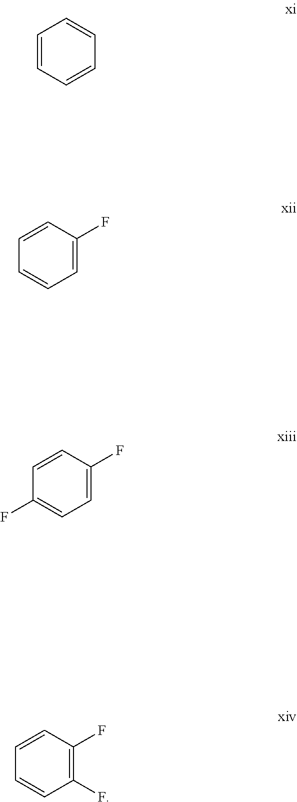 [SMILES: c1ccccc1 ; Fc1ccccc1 ; Fc1ccc(F)cc1 ; Fc1ccccc1F]

Adding anisole end groups increases the thermal stability of the lubricant. A TGA temperature 50% weight loss is 303° C. with one anisole end group:

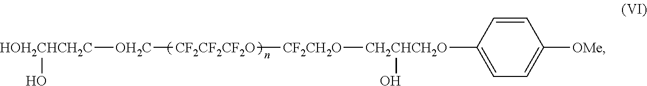

where n can be from 2 to 50.

When two anisole end groups are present, The TGA temperature 50% weight loss increases to 336° C.:

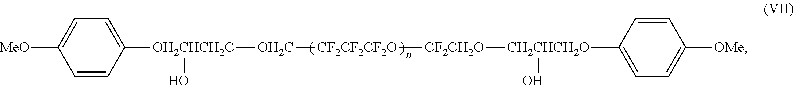

where n can be 2 to 50.

It is clear that anisole end groups provide TGA gain over —OH end groups. The advantages are higher thermal stability (evaporation, oxidation) and enhanced lubricant binding with more polarity.

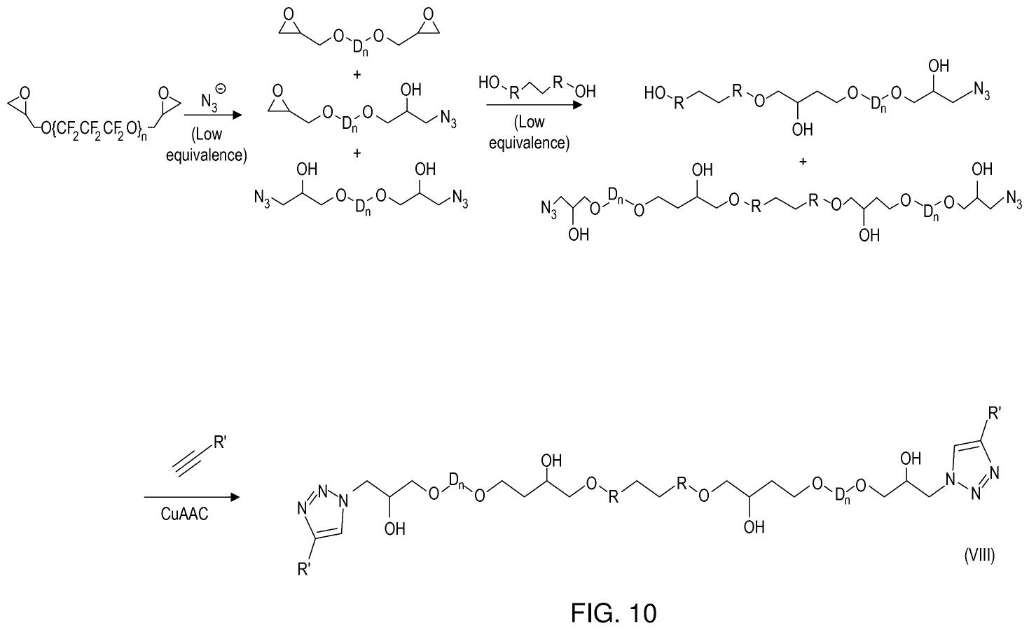

FIG. 10 shows an efficient route to lubricant synthesis and purification is achieved by combining epoxide and CuAAC chemistries, according to aspects of the disclosure. In this embodiment an epoxy is reacted with a low equivalence of N₃⁻ to yield a double azide, a single azide or no azide. A further reaction with a low equivalence PFPE dialcohol yields an intermediate with —N₃ or —OH end groups. A final CuAAC reaction yields a triazole terminated lubricant of formula (VIII):

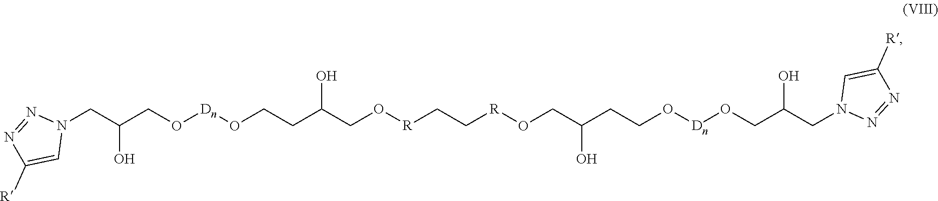

where each R is one of an alkyl moiety, an aromatic moiety (such as benzene, naphthalene, anthracene, phenanthrene, etc.), an alkyl ether moiety, a fluoroalkyl ether moiety, a fluoroalkenyl ether moiety, a perfluoroalkyl ether moiety, a perfluoroalkenyl ether moiety, a P(III) moiety, an amine moiety, a halide, —OH or a combination thereof; D is a perfluoroether group, n is from 2 to 50 and Me is methyl. In this chemistry, the hydroxyl (—OH) groups are optional because the triazole ring acts as an anchoring functional group.

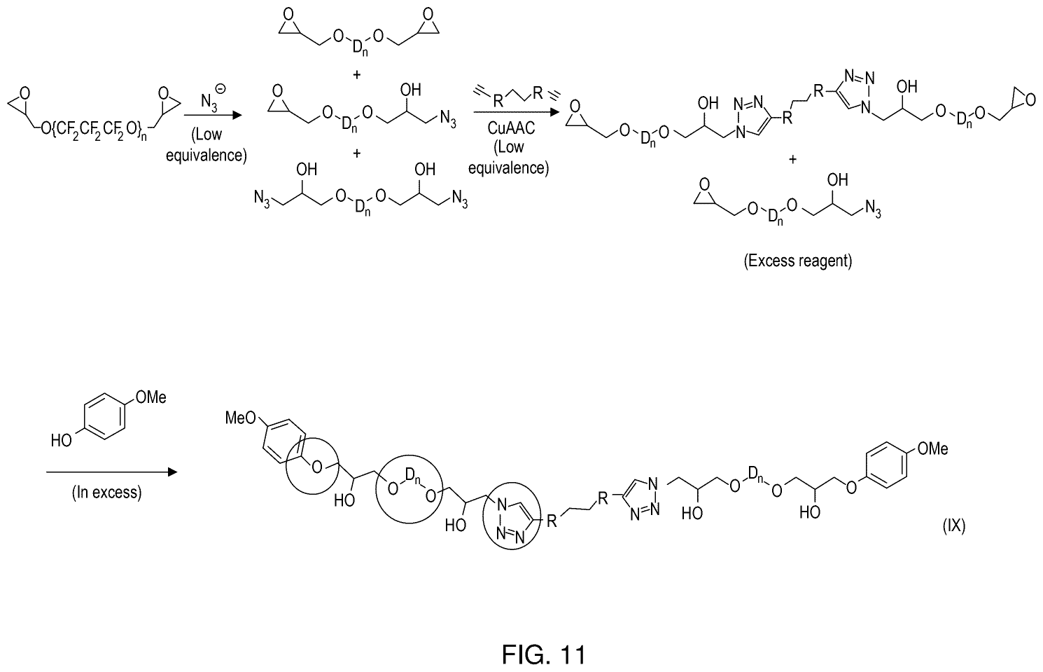

FIG. 11 shows an alternative approach to combining epoxide and CuAAC chemistries, according to aspects of the disclosure. In this embodiment an epoxy is reacted with a low equivalence of N₃⁻ to yield a double azide, a single azide or no azide. A low equivalence CuAAC yields an intermediate with triazole moieties incorporated into the side chains. A final reaction with excess hydroxyanisole yields the final product of formula (IX):

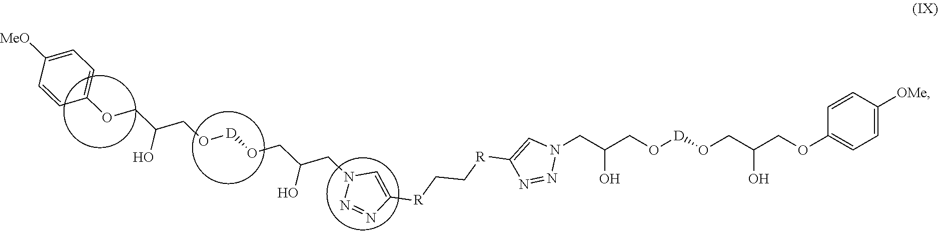

where each R is one of an alkyl ether moiety, a fluoroalkyl ether moiety, a fluoroalkenyl ether moiety, a perfluoroalkyl ether moiety, a perfluoroalkenyl ether moiety, or a combination thereof; D is a perfluoroether group, n is from 2 to 50 and Me is methyl.

The epoxy linkages and click linkages are circled. Here, the end groups are epoxy groups, which are subsequently reacted with 4-hydroxyanisole to provide advantageous anisole end groups. The presence of epoxy moieties at the end of the molecule provides a wide range of possibilities for end group substitution. The anchoring functional groups can be the triazole ring or optionally the hydroxyl (—OH) groups, which need not be present. Dn is a perfluoroether group and n is from 2 to 50.

The result of combining the two chemistries is a higher yield enabled by the quantitative coupling chemistry, with a decrease in the weaker ether linkages. However, some ether linkages will still be in the backbone of the molecule.

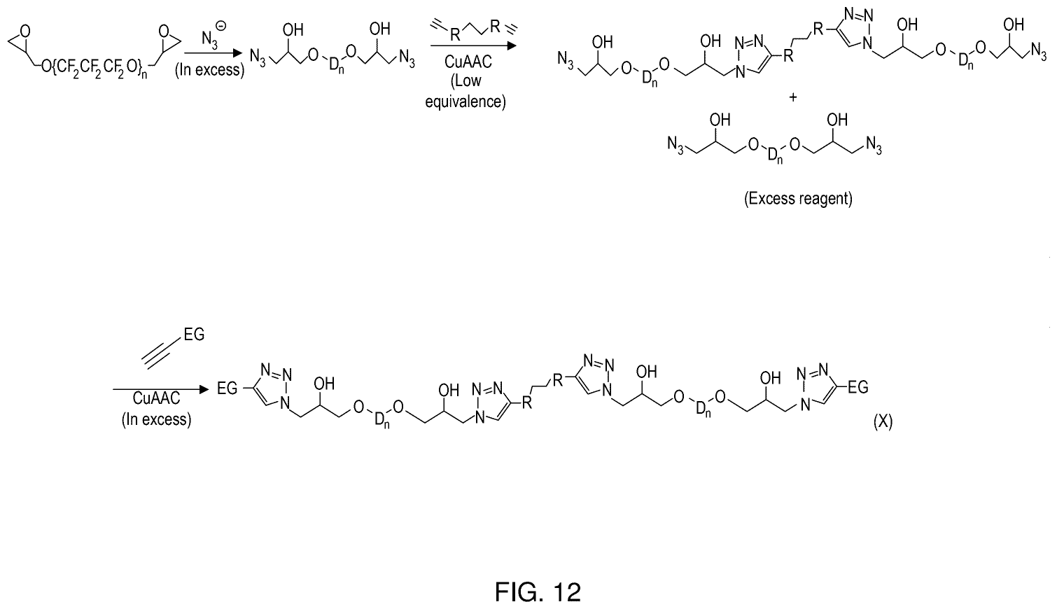

FIG. 12 shows an approach where the primary chemistry can be CuAAC, according to aspects of the disclosure. In this embodiment an epoxy is reacted with excess N₃⁻ to yield a double azide. A low equivalence CuAAC yields an intermediate with triazole moieties incorporated into the side chains. Reacting this intermediate with excess azide reagent and excess CuAAC reagent yields a lubricant of formula (X) with triazole end groups:

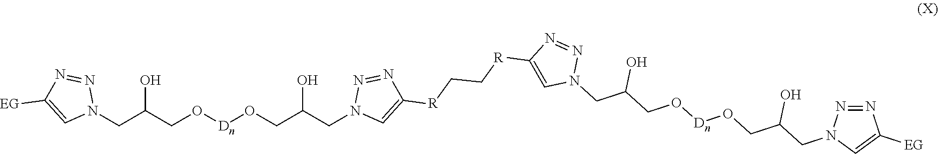

where R is a linking group that can be a fluorinated or non-fluorinated alkyl or aromatic group. EG is the end group which can contain hydrogen (H), halides, fluorinated or non-fluorinated alkyl groups, PFPE groups, aromatic groups (including anisole) and optionally anchoring functioning groups such as hydroxyl (—OH), D is a perfluoroether group and n is from 2 to 50.

In an embodiment, there can be a single click linker group between the end group and the PFPE central group, as can be seen in the CuAAC structure for formula (XI):

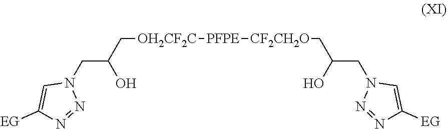

where EG is the end group which can contain hydrogen (H), halides, fluorinated or non-fluorinated alkyl groups, PFPE groups, aromatic groups (including anisole) and optionally anchoring functioning groups such as hydroxyl (—OH). An analogous structure can be obtained using via SuFEx click chemistry, where the triazole group is replaced with the sulfonyl group. Accordingly, the overall structure can be defined as formula (XIa):

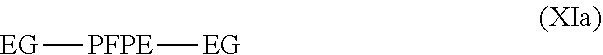

that was made by click chemistry. Also, the triazole group formed by CuAAC click chemistry has some affinity for COC. Moreover, the ring opening of epoxy already introduces an OH group, and thus the EG here could even be H.

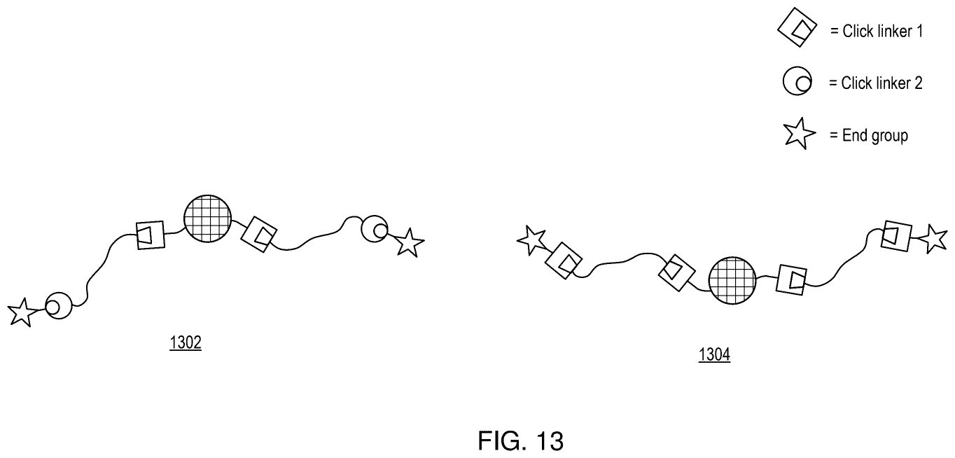

The application of click chemistry opens the gate for a variety of starfish-shaped lubricants, three examples of which can be seen in FIG. 13.

FIG. 13 shows examples of linear shaped fluorinated lubricants with click linkers, according to aspects of the disclosure, where the application of click chemistry opens the gate for a variety of lubricants. In FIG. 13, linear molecule 1302 shows a center to which 2 non-branched arms are attached. There are both types of click linker in the side chains, which can be either a CuAAC 1,2,3-triazole group or a SuFEx sulfone group. Linear molecule 1304 has 2 side chains that were formed a single type of click chemistry, which can be either the CuAAC 1,2,3-triazole group or a SuFEx sulfone group. The click chemistry permits the formation of other types of molecular geometry, which can include stars, branches, rings, dendrimers, etc.

The click chemistry thus permits quantitative and orthogonal click chemistries that make it possible for synthesis of lubes with sophisticated topological structures. The concept of modular design offers simple lube structure modification with greater flexibility.

### Side Chain Segment (Rb)

In one aspect, a lubricant has the general formula (I):

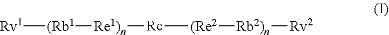

The main chain linking segment -Rc- is optionally free from fluorine. The side chain segments Rb¹ and Rb² include a fluoroalkyl, fluoroalkenyl, perfluoroalkyl, or perfluoroalkyl ether moiety. In one aspect, each chain segment present in the lubricant may have the formula:

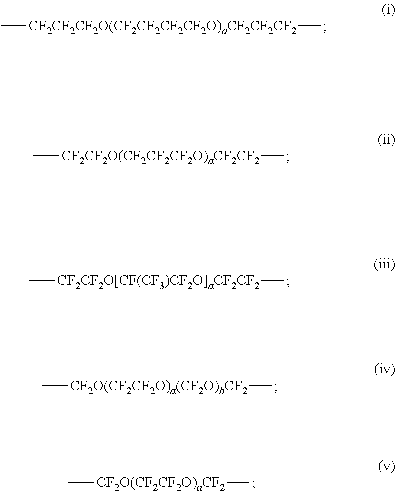

or a combination thereof, wherein each a is, independently from 1 to 100, or from 1 to 20, or from 1 to 10, or from 1 to 5, and wherein each b, when present, is independently from 1 to 100, or from 1 to 20, or from 1 to 10, or from 1 to 5. These chain segments may also appear in general formula (Ia) discussed below.

In another aspect, the lubricant may have the general formula (Ia):

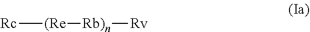

where Rc is a fluorinated or non-fluorinated trivalent, tetravalent, pentavalent, hexavalent, heptavalent, or octavalent linking segment optionally comprising at least one first anchoring functional group engageable with a protective overcoat of a magnetic recording medium;
wherein each Re is a click linker moiety; each Rb is a perfluorinated polyether optionally having an anchoring functional group engageable with a protective overcoat of a magnetic recording medium;
n is 2; and
Rv, if present, is an anchoring functional group.

### End Segment (Rv¹, Rv²)

The end segments Rv¹, Rv² are optional because the click linker moiety has the capacity to bond to the protective overcoat layer of a magnetic recording medium disk, thus making additional anchoring functional groups unnecessary if sufficient bonding is provided by the click linker moieties. In one aspect of the disclosure, each end segment Rv¹ and Rv², if present, may independently include or may have general formula (XII):

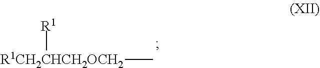

wherein at least one R¹ is an anchoring functional group attachable to and/or engageable with a protective overcoat of a magnetic recording medium, as has been previously defined.

In one aspect, one or more anchoring functional group may include, or is, a hydroxyl (—OH) moiety. In some aspects, each anchoring functional group includes a hydroxyl (—OH) moiety. However, in the disclosure, the presence of an anchoring functional group such as hydroxyl is optional because the click linker 1,2,3-triazole or O═S═O itself acts as an anchoring functional group. Moreover, the presence of the click linker throughout the chain(s) of the molecule creates a denser presence of anchoring functional groups than the conventional anchoring functional groups such as —OH.

In one or more aspects, the lubricant has a weight average molecular weight of greater than or equal to about 0.5 kiloDalton (kDa), or from about 1 to about 20 kDa, or from about 2 to about 10 kDa, or from about 3 to about 7 kDa, or from about 1 to about 5 kDa, or 2 to about 4 kDa.

In one or more aspects, the lubricant has a weight average molecular weight of greater than or equal to about 500 grams per mole (g/mol), or from about 1,000 to about 20,000 g/mol, or from about 2,000 to about 10,000 g/mol, or from about 3,000 to about 7,000 g/mol, or from about 1,000 to about 5,000 g/mol, or 2,000 to about 4,000 g/mol.

In one or more aspects, the lubricants are essentially pure compounds due to the specificity and efficiency of click chemistry. Polydispersity of the lubricants of the disclosure, is defined as the number average molecular weight Mn divided by the weight average molecular weight Mw (Mn/Mw) from about 1 to 2, or from about 1 to about 1.5, or from about 1 to about 1.1, or from about 1 to about 1.05.

In one or more aspects, the average thickness of the lubricant layer of the magnetic recording medium is less than about 10 nanometers (nm), or less than about 5 nm, or less than or equal to about 1 nm. In some aspects, the lubricant of the magnetic recording medium has an average thickness from about 0.1 nm to about 10 nm, or from about 0.1 nm to about 1 nm.

In one or more aspects of the magnetic recording medium, the lubricant may have a bonding percentage of at least about 30%, or at least about 50%, or at least about 70%, or at least about 80%, or at least about 90%, and less than or equal to about 99%, or less than or equal to about 95%, corresponding to a post-stripping bonding level of the lubricant to the total area of an upper surface of the protective overcoat.

### Media Fabrication

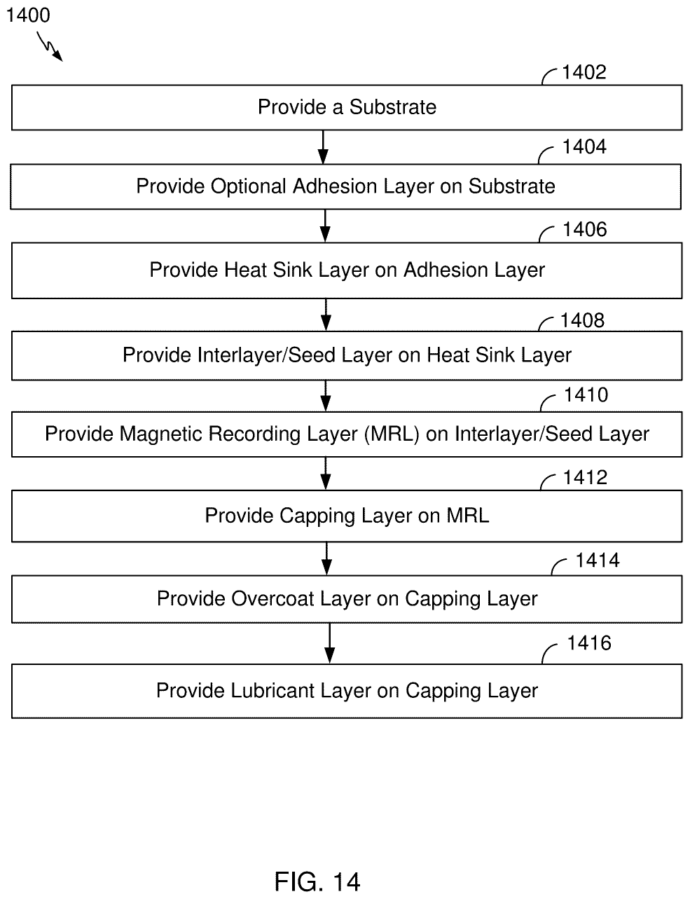

FIG. 14 is a flowchart of an exemplary process 1400 for fabricating a HAMR medium that includes a lubricant in accordance with an aspect of the disclosure. In one aspect, the process 1400 can be used to fabricate the HAMR media described above, including medium 200 shown in FIG. 2.

At block 1402, the process provides a substrate (e.g., substrate 202). At block 1404, the process provides an optional adhesion layer (e.g., adhesion layer 204). At block 1406, the process provides a heat sink layer (e.g., heat sink layer 206). In one aspect, at block 1408, the process may additionally provide an interlayer/seed layer (e.g., interlayer 208). At block 1410, the process provides a magnetic recording layer (MRL) (e.g., MRL 210). At block 1412, the process provides a capping layer (e.g., capping layer 212).

At block 1414, the process provides an overcoat layer (e.g., overcoat layer 214). At block 1416, the process provides a click chemistry lubricant layer (e.g., lubricant layer 218).

It is important to note that in alternative approaches, the lubricant layer formed above the protective overcoat may include any of the multidentate fluoroalkyl, fluoroalkenyl, perfluoroalkyl, or perfluoropolyether boundary lubricants described herein, singly and/or in any combination.

In various aspects, the lubricant layer can be formed on the magnetic recording medium, specifically on the protective overcoat, via a dip coating method. For instance, in one aspect the magnetic recording medium may be dipped into a lubricant bath including the multidentate perfluoropolyether boundary lubricant according to one or more aspects of the disclosure and a fluorocarbon solvent such as HFE7100 (methoxy-nonafluorobutane) or VERTREL-XF (hydrofluorocarbon fluid). After a predetermined amount of time, the magnetic recording medium may be pulled out from the lubricant bath at a controlled rate. The solvent may then evaporate, leaving behind a lubricant layer comprising the multidentate perfluoropolyether boundary lubricant. The bonding percentage is quantified by stripping the lubricated magnetic recording medium with the solvents used in the lubricant bath at various post-lube time periods.

The thickness of the lubricant layer may be tuned by controlling the submergence duration of the magnetic recording medium in the lubricant bath, the rate at which the magnetic recording medium is removed from the coating solution, and/or the concentration of the boundary lubricant (e.g. the lubricant according to one or more aspects of the disclosure) in the lubricant bath.

In one or more aspects, the concentration of lubricant in the lubricant bath may be in a range from about 0.001 g/L to about 1 g/L. In yet other aspects, the concentration of the lubricant in the lubricant bath may be selected so as to achieve a resulting lubricant layer with a thickness in a range of less than or equal to about 10 nanometers (nm), or less than or equal to about 5 nm, or less than or equal to about 1 nm or from 0.1 nm to less than about 1 nm.

Likewise, the formation of the lubricant layer on the surface of the magnetic recording medium, specifically on the surface of the protective overcoat, is not limited to dip coating, but may also involve spin coating, spray coating, a vapor deposition, combinations thereof, or any other suitable coating process as would be understood by one having skill in the art upon reading the present disclosure.

It should be noted that methodology presented herein for at least some of the various aspects may be implemented, in whole or in part, in computer hardware, by hand, using specialty equipment, etc. and combinations thereof.

Moreover, any of the structures and/or steps may be implemented using known materials and/or techniques, as would become apparent to one skilled in the art upon reading the present disclosure.

In some aspects, the processes herein can perform the sequence of actions as described above for media fabrication in a different order. In other aspects, the processes can skip one or more of the actions. In still other aspects, one or more of the actions are performed simultaneously. In some aspects, additional actions can be performed. For example, in one aspect, the process may include any additional actions needed to fabricate the magnetic recording layer structure.

In some aspects, the forming or deposition of such layers can be performed using a variety of deposition sub-processes, including, but not limited to physical vapor deposition (PVD), direct current (DC) sputter deposition, ion beam deposition, radio frequency sputter deposition, or chemical vapor deposition (CVD), including plasma enhanced chemical vapor deposition (PECVD), low pressure chemical vapor deposition (LPCVD) and atomic layer chemical vapor deposition (ALCVD). In other embodiments, other suitable deposition techniques known in the art may also be used.

The terms “on,” “above,” “below,” and “between” as used herein refer to a relative position of one layer with respect to other layers. As such, one layer deposited or disposed on/above or below another layer may be directly in contact with the other layer or may have one or more intervening layers. Moreover, one layer deposited or disposed between layers may be directly in contact with the layers or may have one or more intervening layers.

The click chemistry formed lubricants of the disclosure provide many advantages. Click chemistry as lubricant linker chemistry can be beneficial because it can construct complex PFPE lubes while decreasing or totally eliminating weak ether linkages to afford higher thermal stability. Quantitative and orthogonal click chemistry makes it easier to implement new lube designs with modular synthesis and much decreased synthesis/purification efforts.

Accordingly, the lubricants according to aspects of this disclosure demonstrate improved thermal stability/oxidation resistance, improved contamination robustness at sub-nanometer level, low profile for higher ADC with improved writability/readability, reasonable head wear and flyability performances, an improved bonding ratio, and improved processability/yields with an increased uniformity. The lubricants according to aspects of this disclosure are suitable for use in high-temperature applications while maintaining or improving mechanical interface integration robustness, reliability, and magnetic spacing.

The above description is made for the purpose of illustrating the general principles of the present disclosure and is not meant to limit the inventive concepts claimed herein. Further, particular features described herein can be used in combination with other described features in each of the various possible combinations and permutations.

It should be noted that in the development of any such actual aspect, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the device, system and/or method used/disclosed herein can also comprise some components other than those cited.

### Definition of Terms

Unless otherwise specifically defined herein, all terms are to be given their broadest possible interpretation including meanings implied from the specification as well as meanings understood by those skilled in the art and/or as defined in dictionaries, treatises, and the like.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 20 angstroms (Å) refers to a thickness of 20 Å+/−2 Å, e.g., from 18Å to 22Å in this example.

In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.” The term “and/or” refers to both the inclusive “and” case and the exclusive “or” case, and such term is used herein for brevity. For example, a composition comprising “A and/or B” may comprise A alone, B alone, or both A and B.

Various components described in this specification may be described as “including” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. It is further noted that the term “over” as used in the present application in the context of one component located over another component, may be used to mean a component that is directly on another component and/or in another component (e.g., directly on a surface of a component or embedded in a component). Thus, for example, a first component that is over the second component may mean that (1) the first component is over the second component, but not directly touching the second component, (2) the first component is directly on (e.g., directly on a surface of) the second component, and/or (3) the first component is in (e.g., embedded in) the second component. The term “about ‘value X’”, or “approximately value X,” as used in the disclosure shall mean within 10 percent of the ‘value X’. For example, a value of about 1 or approximately 1 would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. In the disclosure various values (e.g., value X) may be specified, described and/or claimed. In one embodiment, it should be understood that the value X may be exactly equal to X. In one embodiment, it should be understood that the value X may be “about X,” with the meaning noted above.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

What is claimed is:

1. A lubricant comprising a plurality of segments according to general formula (I): 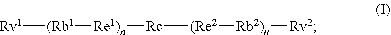
wherein Rc is a fluorinated or non-fluorinated divalent linking segment optionally comprising at least one least one first anchoring functional group engageable with a protective overcoat of a magnetic recording medium;
wherein each Re¹ and Re² is a click linker moiety;
n is from 2 to 50;
wherein each Rb¹ and Rb² is an optionally non-fluorinated divalent linking segment optionally comprising at least one least one first anchoring functional group engageable with a protective overcoat of a magnetic recording medium;
wherein each Re¹ and Re² is a click linker moiety;
n is from 2 to 50; and
wherein each of Rv¹ and Rv², when present, independently comprises a moiety having at least one second anchoring functional group engageable with the protective overcoat of the magnetic recording medium.

2. The lubricant of claim 1, wherein the click linker moiety is:

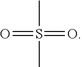

3. The lubricant of claim 1, wherein the click linker moiety is:

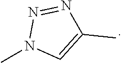

4. The lubricant of claim 1, wherein the at least one first and second anchoring functional groups each comprises at least one of B, Si, a pnictogen, a chalcogen, a halogen, —OR*, —NR*₂, —NR*—CO—R*, —O—CO—R*, —CO—O—R*, —SeR*, —TeR*, —PR*₂,—PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

5. The lubricant of claim 1, wherein the at least one first and second anchoring functional groups each comprises a hydroxyl (—OH) moiety.

6. The lubricant of claim 1, wherein the at least one first and second anchoring functional groups are not present.

7. The lubricant of claim 1, having the formula (V): 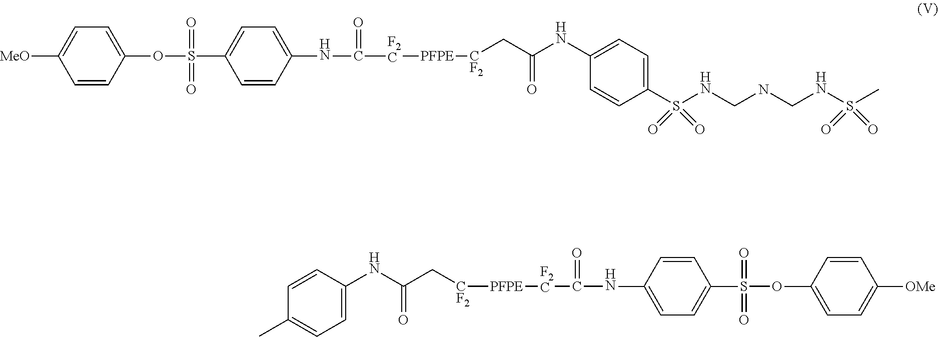
where PFPE is a perfluorinated polyether and each R is one of an alkyl ether moiety, a fluoroalkyl ether moiety, a fluoroalkenyl ether moiety, a perfluoroalkyl ether moiety, a perfluoroalkenyl ether moiety, or a combination thereof.

8. The lubricant of claim 1, having the formula (IX): 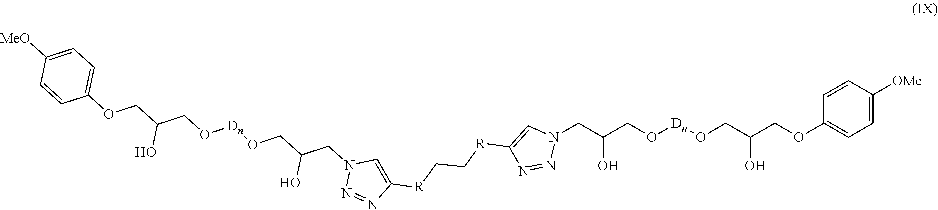
where each R is one of an alkyl ether moiety, a fluoroalkyl ether moiety, a fluoroalkenyl ether moiety, a perfluoroalkyl ether moiety, a perfluoroalkenyl ether moiety, or a combination thereof; D is a perfluoroether group, n is from 2 to 50 and Me is methyl.

9. The lubricant of claim 1, having the formula (X): 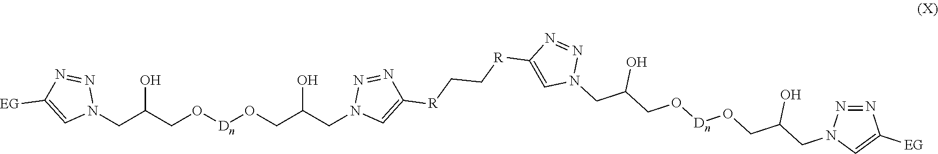
where each R is one of an alkyl ether moiety, a fluoroalkyl ether moiety, a fluoroalkenyl ether moiety, a perfluoroalkyl ether moiety, a perfluoroalkenyl ether moiety, or a combination thereof, D is a perfluoroether group, n is from 2 to 50 and each EG is an end group comprising an aromatic moiety, a substituted or unsubstituted alkyl moiety, alkenyl moiety, fluoroalkyl ether moiety, fluoroalkenyl ether moiety, perfluoroalkyl ether moiety, perfluoroalkenyl ether moiety, or a combination thereof.

10. A magnetic recording medium, comprising:
a magnetic recording layer on a substrate;
a protective overcoat on the magnetic recording layer; and
a lubricant layer comprising the lubricant according to claim 1 on the protective overcoat.

11. A data storage system, comprising:
at least one magnetic head;
a magnetic recording medium including the lubricant of claim 1;
a drive mechanism for positioning the at least one magnetic head over the magnetic recording medium; and
a controller electrically coupled to the at least one magnetic head for controlling operation of the at least one magnetic head.

12. A lubricant having the formula (Ia): 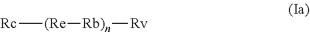
where Rc is a fluorinated or non-fluorinated trivalent, tetravalent, pentavalent, hexavalent, heptavalent, or octavalent linking segment optionally comprising at least one first anchoring functional group engageable with a protective overcoat of a magnetic recording medium;
wherein each Re is a click linker moiety;
each Rb is a perfluorinated polyether optionally having an anchoring functional group engageable with a protective overcoat of a magnetic recording medium;
n is 2; and
Rv, if present, is an anchoring functional group.

13. The lubricant of claim 12, wherein Rv is not present.

14. The lubricant of claim 12, wherein the click linker moiety is:

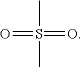

15. The lubricant of claim 12, wherein the click linker moiety is:

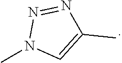

16. The lubricant of claim 12, wherein the anchoring functional groups, if present, each comprises at least one of B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

17. The lubricant of claim 12, wherein the anchoring functional groups, if present, each comprises a hydroxyl (—OH) moiety.

18. The lubricant of claim 12, wherein the anchoring functional groups are not present.

19. A magnetic recording medium, comprising:
a magnetic recording layer on a substrate;
a protective overcoat on the magnetic recording layer; and
a lubricant layer comprising the lubricant according to claim 12 on the protective overcoat.

20. A data storage system, comprising:
at least one magnetic head;
a magnetic recording medium including the lubricant of claim 12;
a drive mechanism for positioning the at least one magnetic head over the magnetic recording medium; and
a controller electrically coupled to the at least one magnetic head for controlling operation of the at least one magnetic head.
